(19) United States
(12) Patent Application Publication
(10) Pub. No.: US 2017/0317641 A1
(43) Pub. Date: Nov. 2, 2017

(54) BEARING SHAFT FOR PHOTOVOLTAIC MODULES AND SYSTEM HAVING A NUMBER OF PHOTOVOLTAIC MODULES

(71) Applicant: RaiPro GmbH, Moosthenning (DE)

(72) Inventor: Johann Rainer, Moosthenning (DE)

(73) Assignee: RaiPro GmbH, Moosthenning (DE)

(21) Appl. No.: 15/528,319

(22) PCT Filed: Nov. 11, 2015
(86) PCT No.: PCT/EP2015/076360

§ 371 Date: May 19, 2017

(30) Foreign Application Priority Data
Nov. 21, 2014 (DE) 20 2014 105 615.7

(51) Int. Cl. H02S 20/32; F24J 2/52; F24J 2/54; F16D 1/10

(52) U.S. Cl. CPC H02S 20/32; F24J 2/541; F24J 2/526; F16D 1/101; F16D 2001/102; F24J 2002/5444; F24J 2002/5482

(57) ABSTRACT

A bearing axle for photovoltaic modules includes at least two tubes, which each have a non-circular cross section at least in one end region. The non-circular cross sections of the at least two tubes are designed to correspond to each other such that a non-rotatable connection between at least one first and at least one second of the at least two tubes can be produced by way of inserting the at least one first of the at least two tubes into the at least one second of the at least two tubes. The bearing axle includes at least one separate connection means, which can be arranged intermediately between at least two tubes, and by way of which the particular at least two tubes are connectible non-rotatably to each other by form-lockingly coupling the at least one connection means to their free end regions with non-circular cross sections.

### CROSS-REFERENCE TO RELATED APPLICATION

This application claims priority from German Application No. 202014105615.7 filed Nov. 21, 2014, the contents of which are incorporated herein by this reference.

### BACKGROUND

The present invention relates to a bearing axle for photovoltaic modules as well as to a system having a plurality of photovoltaic modules.

Collector areas that have a plurality of photovoltaic modules are already known in the prior art. In order to support the photovoltaic modules and align them with the current position of the sun, if required, by way of an active swivel movement, of the individual photovoltaic modules are connected to appropriate axle systems.

Such an apparatus with a plurality of photovoltaic modules is, for instance, shown in EP 2 398 064 A1. The open-space photovoltaic system disclosed in the EP patent application includes a multitude of photovoltaic modules as well as a multitude of axles to which the modules are fastened. The axles are supported by way of a cross brace or are in connection to a cross brace, as the case may be. The cross brace has a receptacle in which two adjacent axles are arranged. The particular axles are fastened by way of a bolt connection in the receptacle.

Such a coupling of adjacent axles by means of bolt connections is also shown in U.S. 2015/0092383 A1. The axle of the U.S. patent bears a support unit for photovoltaic modules, which support unit consists of two separate parts that can be mechanically coupled to each other. The axle is further coupled to support legs, which can be anchored in a ground surface.

If open-space photovoltaic systems are to be erected according to the described prior art, the individual axles each have to be fastened to the cross brace by way of bolt connections, thus involving a large amount of time consumed. In the event of the bolt breaking, it is also likely that the arrangement will be damaged. In addition, bolt connections are poorly suited for coupling two adjacent axles if the particular axles are to be swiveled with each other. The torque that can be transmitted from one axle to an adjacent axle by way of the bolt connection is limited because an according bolt connection can only withstand a certain torque before it breaks.

### SUMMARY OF INVENTION

One object of the invention is therefore to provide a bearing axle for a plurality of photovoltaic modules, which bearing axle can be put together or, as the case may be, installed in a simple and uncomplicated manner. In addition, the bearing axle should have great stability and the risk of damage should be kept low even under the application of considerable force on the bearing axle. It is also an object of the invention to provide a system with a plurality of photovoltaic modules and a method for erecting a system having a plurality of photovoltaic modules, which system and method have the advantages mentioned above.

The above objects are fulfilled by a bearing axle, a system, and a method, which have the features identified in claims 1, 20, and 23. Further advantageous embodiments of the invention are described in the dependent claims.

The invention relates to a bearing axle for a plurality of photovoltaic modules, the bearing axle comprising at least two tubes, each of which have a non-circular cross section at least in one end region. In other regions adjacent to the particular end region with a non-circular cross section, one or more of the at least two tubes can have a circular or an at least approximately circular cross section. In the region of the circular cross sections of the at least two tubes, the photovoltaic modules can be fastened to the bearing axle or to the at least two tubes, as the case may be.

It is conceivable that the non-circular cross section has an elliptical geometry. In preferred embodiments, however, the geometry of the non-circular cross section can have a polygonal geometry, as will be described below.

The non-circular cross sections of the at least two tubes can furthermore be designed to correspond to each other such that a non-rotatable connection between the at least one first and the at least one second of the at least two tubes can be produced by way of inserting the at least one first of the at least two tubes into the at least one second of the at least two tubes. The end regions of the at least two tubes can thus be joined together, as the case may be, by inserting one end region into a further end region.

Alternatively, or additionally, it can be provided that the bearing axle comprises at least one separate connection means which can be arranged intermediately between at least two tubes, and by way of which the particular at least two tubes are non-rotatably connectible to each other by form-lockingly coupling the at least one connection means to their end regions having non-circular cross sections.

Thus, embodiments can exist in which a non-rotatable connection between two tubes of the bearing axle is formed directly by putting together their free end regions, with a form-locking coupling of a free end region of one of these tubes with a free end region of a further tube being additionally produced by way of a connection means.

In particularly preferred embodiments, it can moreover be provided that the particular non-circular cross section of the at least two tubes at least in sections has a polygonal geometry. In this context it is possible that the particular non-circular cross section of the at least two tubes at least in sections has an at least hexagonal and preferably an at least octagonal geometry. Practice has shown that in such embodiments a high torque can be transmitted from a first of the at least two tubes to a second of the at least two tubes without hereby entailing a damage or, as the case may be, a deformation of the at least two tubes.

It is furthermore possible that the at least one first of the at least two tubes has a maximum sectional diameter in the region of its non-circular cross section, which maximum sectional diameter is designed to be smaller than the maximum sectional diameter of a region adjacent to the particular end region. It is in particular possible that an outside diameter of the end region of the at least one first of the at least two tubes and an inside diameter of the end region of the at least one second of the at least two tubes are designed such that the end region of the at least one first of the at least two tubes can be inserted under press fit into the end region of the at least one second of the at least two tubes.

It is moreover possible that in its end region the at least one first of the at least two tubes terminates in a connector end, the cross section of which successively decreases. The particular tube can thus have its smallest sectional diameter at the end of that particular tube. In preferred embodiments, each of the at least two tubes in at least one of its end regions terminates in such a connector end. The joining together of two tubes by inserting is thus facilitated.

It is also possible that the connector end, in cross section, follows a profile which has radial projections and recesses in relation to a longitudinal axis of the particular at least one first tube. The longitudinal axis can in this context form a symmetry axis of the at least one first tube or, as the case may be, of the bearing axle. The radial projections and recesses of the particular connector end can be formed by an at least approximated wave-formed profile of the at least one first of the at least two tubes.

Furthermore, one or more of the at least two tubes can each have a transition section, with which the particular tube connects to a region adjacent to the end region, with the sectional diameter of the transition section successively increasing toward the adjacent region. The transition section of the particular tube can likewise have a polygonal geometry in cross section.

As already mentioned above, the bearing axle can have one or more connection means, which can be arranged intermediately between at least two tubes, and which connects the particular at least two tubes non-rotatably to each other. It is possible in this context that a bearing axle consists of more than two tubes and that all tubes that are adjacent to each other are in each case coupled non-rotatably to each other by one connection means. In further embodiments, merely a few, or none, of the respectively adjacent tubes can be coupled to each other non-rotatably by way of a connection means.

In preferred embodiments, the at least one connection means comprises two free end regions, by way of which a non-rotatable connection between the at least one first and the at least one second of the at least two tubes can be produced by way of a free end region of at least one first of the at least two tubes of the connection means being inserted into, or slipped onto, a free end region of an at least one second of the at least two tubes. It is also possible that the two free end regions of the at least one connection means each have a cross section with a polygonal geometry. In particular, embodiments have proved successful in which the two free end regions of the connection means each have a cross section with an at least hexagonal and preferably an at least octagonal geometry. Such embodiments further have the advantage that a high torque can be transmitted between two adjacent tubes by way of the at least one connection means without resulting in damage or deformation of the tubes or of the at least one connection means.

It is moreover possible that the two free end regions of the at least one connection means each have a maximum sectional diameter that is designed to be smaller than in a region of the at least one connection means, which region is arranged intermediately between the free end regions. For preferred embodiments, it is also possible to provide that a particular diameter of the free end regions of the connection means and a diameter of a particular free end region of the at least two tubes is designed such that the free end regions of the at least one connection means and the at least two tubes can be brought into connection to each other under press fit.

It is furthermore possible that in at least one free end region the at least one connection means terminates in a connector end, the sectional diameter of which successively decreases with the distance from the opposite free end region of the at least one connection means. In particular, each connector end can, in cross section, follow a profile which has radial projections and recesses in relation to a longitudinal axis of the at least one connection means. The radial projections and recesses can be spread evenly around the circumference of the connector end.

It is also possible that the radial projections and recesses of the particular connector end are formed by an at least approximated wave-formed profile of the at least one first of the at least two tubes. The at least approximated wave-formed profile can extend around a longitudinal axis of the particular at least one of the at least two tubes.

In particularly preferred embodiments, the at least one connection means can have at least one transition section, which adjoins at least one free end region of the at least one connection means, with the sectional diameter of the transition section successively increasing toward the—in each case—oppositely located free end region. The transition section can also have a polygonal geometry in cross section.

Furthermore, a section having a circular cross section can connect to the free end regions of the at least one first of the at least two tubes and/or to the free end regions of the at least one second of the at least two tubes.

The invention moreover relates to a system with a plurality of photovoltaic modules. The system comprises at least one bearing axle that is designed according to the preceding description. At least one photovoltaic module is fastened to the at least one bearing axle, with the at least one bearing axle being connected to support legs, which are designed for erecting the system on a ground surface.

It is moreover possible that the at least one bearing axle is connected to an actuator, by means of which the at least one bearing axle as well as the at least one photovoltaic module fastened to the at least one bearing axle can be swiveled. In such an instance, embodiments have proved particularly successful in which tubes of the bearing axles and/or the above described at least one connection means have a polygonal cross section in their free end regions. In this way it is possible to minimize the risk of damage or deformation of the one or more bearing axles even under high torque.

If the at least one bearing axle has a section with a circular cross section as described above, it is possible that the at least one photovoltaic module rests on the section with the circular cross section and/or is fastened on the section with the circular cross section.

The invention moreover relates to a method for erecting a system with a plurality of photovoltaic modules. Features described above relating to the system and to the bearing axle can likewise be provided for the method according to the invention. Furthermore, features described below can likewise be provided for the above described bearing axle or for the above described system.

The method according to the invention comprises the following steps:
assembling a bearing axle for photovoltaic modules, with free end regions of at least two tubes, each having non-circular cross section, being put together in a form-locking and non-rotatable manner;
connecting a plurality of support legs to the bearing axle and anchoring the bearing axle in a ground surface by way of the plurality of support legs; and
fastening a plurality of photovoltaic modules to the bearing axle such that the photovoltaic modules of the plurality of photovoltaic modules are held in a non-rotatable manner by the bearing axle.

In particularly preferred embodiments, it can be provided that at least two tubes are put together by way of a common connection means, which is arranged intermediately between the at least two tubes, and to which the at least two tubes each come into connection in a form-locking and non-rotatable manner.

It is likewise possible that the free end regions of at least two tubes are put together in a directly form-locking and non-rotatable manner or, as the case may be, without the at least one connection means.

### BRIEF DESCRIPTION OF THE DRAWINGS

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged in relation to other elements to facilitate an understanding of the invention.

FIGS. 1A and 1B show a schematic perspective view of an embodiment of a bearing axle according to the invention;

FIG. 2 shows a schematic view of a tube that can be provided as a component for various embodiments of a bearing axle according to the invention;

FIG. 3 shows a front view onto the tube from FIG. 2;

FIG. 4 shows a cross-sectional illustration through the free end regions of the tube from the FIGS. 1 to 3;

FIG. 5 shows a longitudinal cut through a bearing axle in an assembled state according to FIG. 1B,

FIGS. 6A and 6B show a schematic view of a further embodiment of a bearing axle according to the invention;

FIG. 7 shows a longitudinal cut through the embodiment of a bearing axle from the FIGS. 6A and 6B;

FIG. 8 shows a detailed view of the connection means of the bearing axle from the FIGS. 6A, 6B, and 7;

FIG. 9 shows a schematic cross section through the connection means from FIG. 8;

FIG. 10 shows a cross section through the free end regions of the tube of the bearing axle from the FIGS. 6A, 6B, and 7; and

FIG. 11 shows a schematic view of an embodiment of a system according to the invention.

### DETAILED DESCRIPTION

The same or equivalent elements of the invention are designated by identical reference characters. Furthermore and for the sake of clarity, only the reference characters relevant for describing each of the figures are provided. It should be understood that the detailed description and specific examples, while indicating preferred embodiments, are intended for purposes of illustration only and are not intended to limit the scope of the invention.

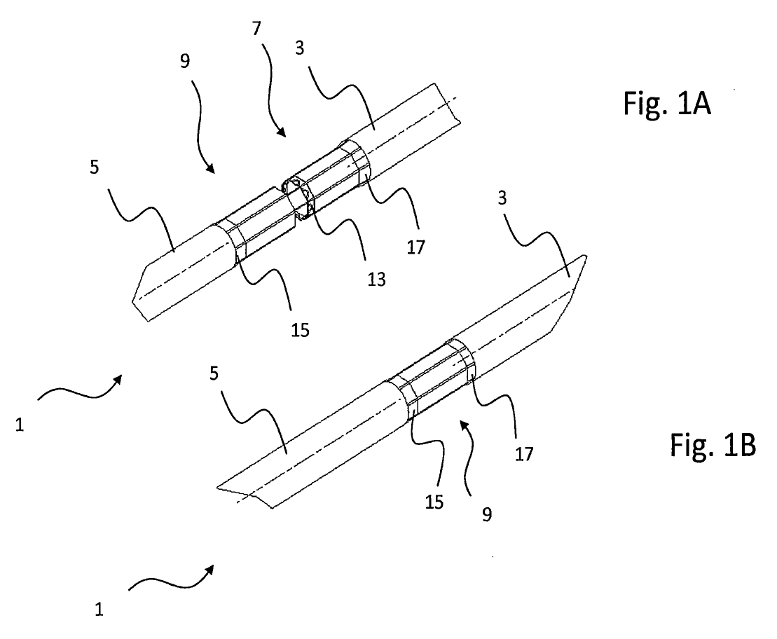

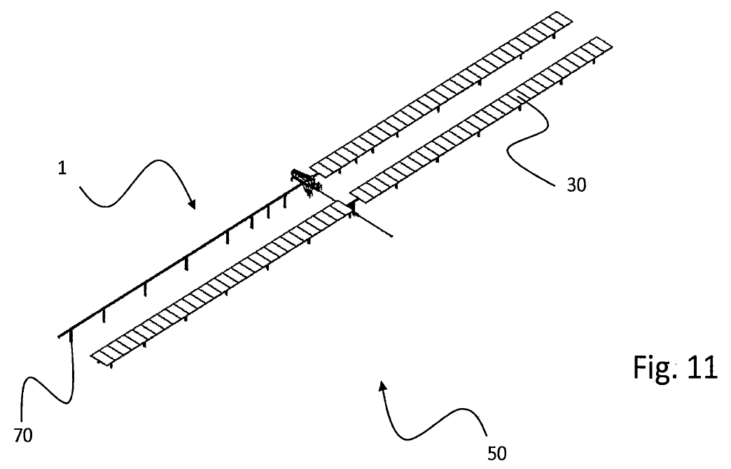

FIGS. 1A and 1B show a schematic perspective view of an embodiment of a bearing axle 1 according to the invention. The bearing axle 1 is provided for holding a plurality of photovoltaic modules 30 (cf. FIG. 11), and it can be designed as a swivel axis, for example.

The bearing axle 1 comprises a multitude of tubes. Of these tubes, a first tube 3 and a second tube 5 are discernible in FIG. 1. The number of tubes can be selected according to a desired length for the bearing axle 1.

The two tubes 3 and 5 each have a circular cross section along the greater part of their longitudinal extension. Circular cross sections have proved particularly successful for these regions in order for the two tubes 3 and 5 to be able to withstand an as high as possible torque without being deformed.

Both the first tube 3 and the second tube 5 have an end region 7 and 9, where the end region 7 of the first tube 3 can be inserted into the end region 9 of the second tube 5 after aligning the two tubes 3 and 5 with each other. In this context, the sectional diameter of the end regions 7 and 9 are selected such that the end region 7 of the first tube 3 can be inserted under press fit into the end region 9 of the second tube 5. The maximum sectional diameter of the end regions 7 and 9 is smaller than in the other regions of the first and the second tube 3 and 5, where the tubes 3 and 5 have a circular sectional diameter.

FIG. 1A here shows the alignment of the two tubes 3 and 5 with each other before the end region 7 of the first tube 3 has been inserted into the end region 9 of the second tube 5. FIG. 1B next shows the bearing axle 1 with the end region 7 of the first tube 3 inserted into the end region 9 of the second tube 5. The end regions 7 and 9 are designed to correspond to each other such that a non-rotatable connection between the two tubes 3 and 5 is formed after inserting the first end region 7 into the second end region 9. The other free end regions—not discernible in FIGS. 1A and 1B—of the tubes 3 and 5 can be designed according to the free end regions 7 and 9 already discernible in FIGS. 1A and 1B such that further tubes can be connected non-rotatably to the first tube 3 and to the second tube 5 by appropriately inserting them.

Furthermore, it is illustrated that the free end regions 7 and 9 of the first tube 3 and of the second tube 5 in cross section have a polygonal or, as is the case here, an octagonal geometry. In practice, such geometries for the end regions 7 and 9 have proved successful in order to counteract an undesired deformation of free end regions 7 and 9 even with high torque transmission between the two tubes 3 and 5.

It is moreover discernible in FIGS. 1A and 1B that in its end region 7 the first tube 3 terminates in a connector end 13, the sectional diameter of which successively decreases with the distance from the first tube 3 and accordingly toward the second tube 5. The insertion of the end region 7 of the first tube 3 into the end region 9 of the second tube 5 can be facilitated by the connector end 13.

Both the first tube 3 and the second tube 5 moreover each have a transition section 15 or 17, as the case may be, by way of which the end region 7 or 9, as the case may be, of the particular tube 3 or 5, as the case may be, connects to a region with a circular sectional diameter. The cross section of the particular transition section 15 or 17, as the case may be, successively increases toward the particular region with the circular sectional diameter. The distance up to which the end region 7 of the first tube 3 can be inserted into the end region 9 of the second tube 5 can be limited by the transition sections 15 and 17, because the end region 9 of the second tube 5 comes to abut against the transition section 17, whereby a further insertion of the first tube 3 into the second tube 5 is prevented.

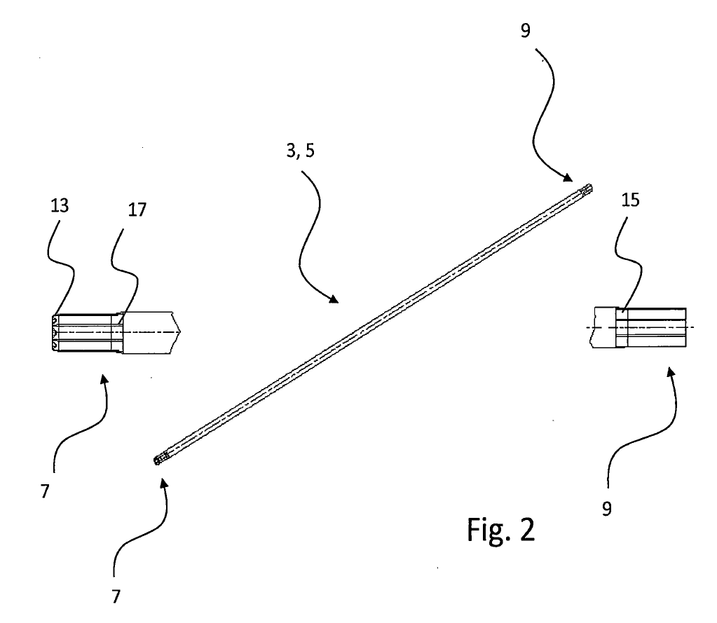

FIG. 2 shows a schematic view of a tube 3 or 5, as the case may be, that can be provided as a component for various embodiments of a bearing axle 1 according to the invention. The tube 3 or 5, as the case may be, is likewise used for the bearing axle 1 according to the exemplary embodiment from FIG. 1. From FIG. 2 it is clearly discernible in this instance that the oppositely located end regions 7 and 9 each have a polygonal profile. Thus, both end regions 7 and 9 are designed according to the end regions 7 and 9 as illustrated in FIG. 1. The longitudinal extension for both end regions 7 and 9 is at least approximately identical. The outside diameter of the end region 7 is selected to be slightly larger than the inside diameter of the end region 9. By inserting under press fit the appropriate end regions 7 or 9, as the case may be, a plurality of tubes 3 and 5 can therefore be connected non-rotatably to each other. As is shown in FIG. 2, a bearing axle 1 can be assembled from a multitude of tubes 3 or 5, as the case may be, with an end region 7 of a first tube 3 in each case being inserted into an end region 9 of a second tube 5 (cf. FIGS. 1).

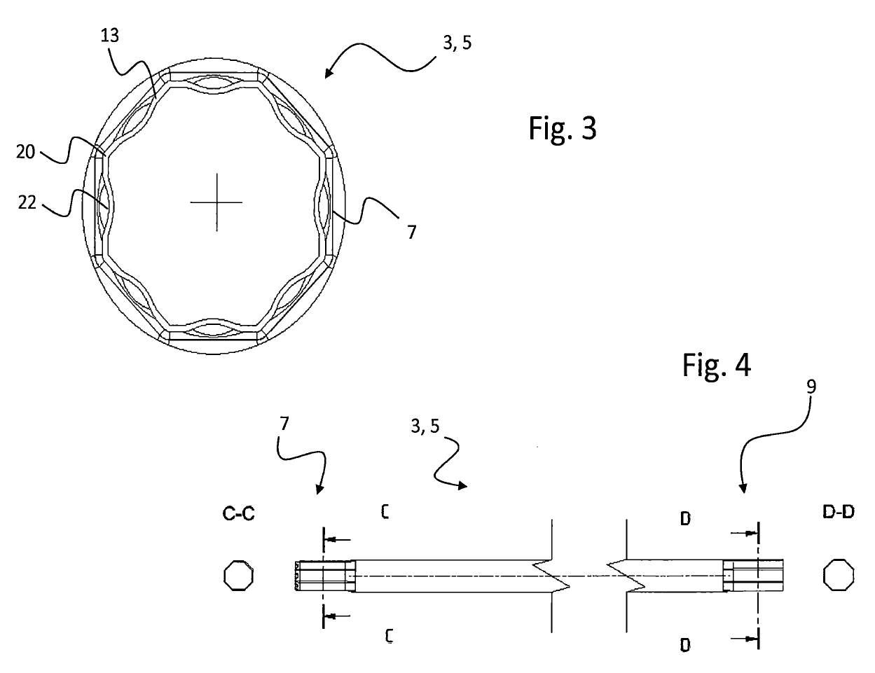

FIG. 3 shows a front view onto the tube 3 or 5, as the case may be, from FIG. 2. In this instance, the front view shows an illustration of the face side onto the end region 7. The polygonal or, as is the case here, the octagonal geometry of the end region 7 is again clearly discernible in FIG. 3. Furthermore, the connector end 13 is discernible, which in the face view and in cross section follows a profile that has radial projections 20 and radial recesses 22 in relation to a longitudinal axis of the tube 3 or 5, as the case may be. As is clearly discernible in FIG. 3, the radial projections 20 and the radial recesses 22 are formed by an at least approximated wave-formed profile of the connector end 13 and accordingly of the end region 7.

FIG. 4 shows a cross-sectional illustration through the free end regions 7 and 9 of the tube 3 or 5, as the case may be, from the FIGS. 1 to 3. FIG. 4, in particular, once more shows the polygonal or, as is the case here, the octagonal geometry of both end regions 7 and 9 of the tube 3 or 5, as the case may be.

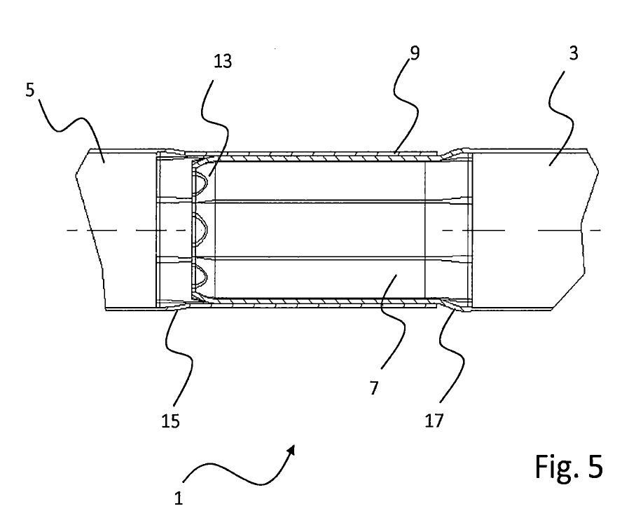

FIG. 5 shows a longitudinal cut through a bearing axle 1 in an assembled state according to FIG. 1B. The end region 9 of the second tube 5 borders directly on the transition section 17 of the first tube 3. By way of the transition section 17, the first tube 3 is in this context prevented from being inserted any further, based on the position from FIG. 5, into the second tube 5. By the end regions 7 and 9 being designed to correspond to each other, the two tubes 3 and 5 are coupled non-rotatably to each other.

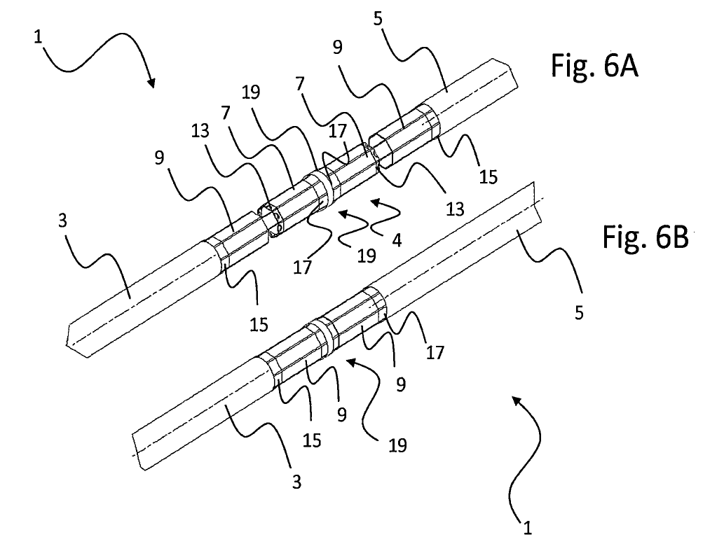

FIGS. 6A and 6B show a schematic view of a further embodiment of a bearing axle 1 according to the invention. The bearing axle 1 comprises two tubes 3 and 5, between which a separate connection means 4 for the non-rotatable connection of the two tubes 3 and 5 can be intermediately arranged. FIGS. 6A and 6B in this context show a connection means 4 with two end regions 7, which are each designed according to the end region 7 of the first tube 3 from FIGS. 1A and 1B. The intermediate region 19 of the connection means 4 in each case connects to the end regions 7. The tubes 3 and 5 each have an end region 9, which is designed according to the end region 9 of the second tube 5 from FIGS. 1A and 1B. The end regions 9 of the two tubes 3 and 5 correspond to the end regions 7 of the connection means 4. The end regions 7 of the connection means 4 can therefore be inserted into the end regions 9 of the two tubes 3 and 5 and hereby connect the two tubes 3 and 5 non-rotatably to each other. A connector end 13 according to the first tube 3 from FIGS. 1A and 1B is also a component of the connection means 4. FIG. 6A shows the first tube 3 and the second tube 5 in a non-assembled state. FIG. 6B shows the bearing axle 1 with the end regions 7 of the connection means 4 already inserted into the end regions 9 of the first and second tube 3 and 5.

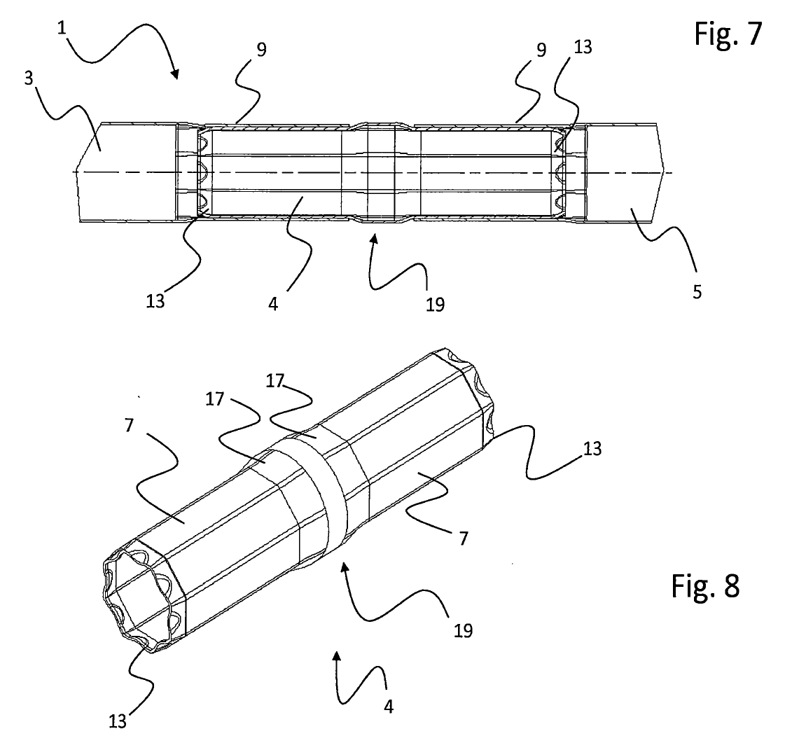

FIG. 7 shows a longitudinal cut through the embodiment of a bearing axle 1 from FIGS. 6A and 6B. The intermediate region 19 of the connection means 4, which has the maximum sectional diameter of the connection means 4, is once more clearly discernible. It is possible in further conceivable embodiments that the intermediate region 19 is formed by a joint, which allows a tilt adjustment of the first tube 3 in relation to the second tube 5. A non-rotatable connection between the first tube 3 and the second tube 5 is produced by way of the connection means 4.

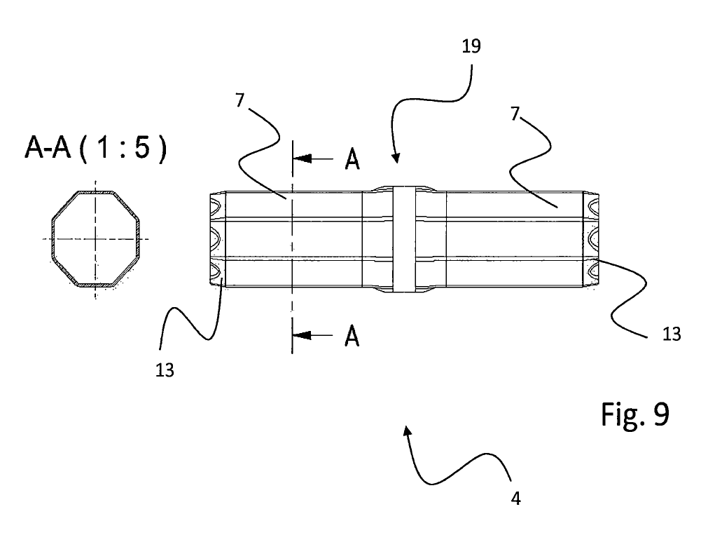

FIG. 9 shows a schematic cross section through the connection means 4 from FIG. 8. Again, the polygonal geometry of the end regions 7 of the connection means 4 is discernible. In practice, an at least octagonal geometry has proved particularly successful for the ability to transmit a high torque between the two tubes 3 and 5 without damaging or deforming one or more of the two tubes 3 or, as the case may be, 5 and/or the connection means 4.

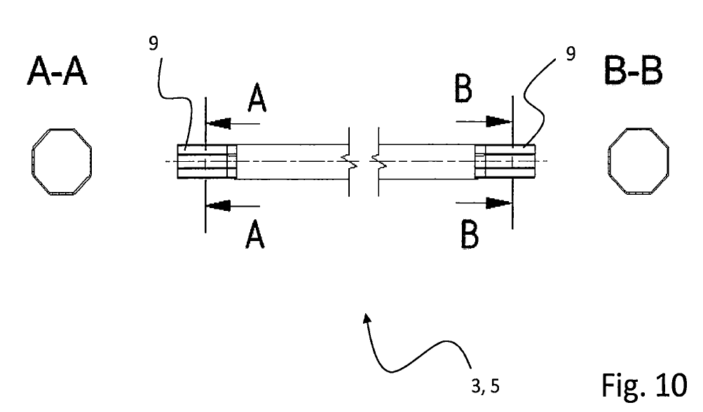

FIG. 10 shows a cross section through the free end regions 9 of the tube 3 or, as the case may be, 5 of the bearing axle 1 from the FIGS. 6A, 6B, and 7. The two oppositely located end regions 9 have an identical or, more precisely, a polygonal cross section, which is designed to correspond to the end region 7 of the connection means 4 (cf. FIG. 8). After inserting the connection means 4 with one of its end regions 7 into an end region 9, connection means 4 and tube 3 or, as the case may be, 5 are non-rotatably connected to each other.

FIG. 11 shows a schematic view of an embodiment of a system 50 according to the invention. The system 50 comprises a plurality of photovoltaic modules 30 as well a bearing axle 1, which is formed from a multitude of tubes 3 or, as the case may be, 5 as illustrated in the previous figures, which tubes 3 or, as the case may be, 5 are non-rotatably connected to each other. Multiple photovoltaic modules 30 are coupled to the bearing axle 1. A common swivel movement of the photovoltaic modules 30 can be effected by way of a swivel movement of the bearing axle 1. The bearing axle 1 is moreover connected to a plurality of support legs 70, by way of which the system 50 is anchored in a ground surface.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

### LIST OF REFERENCE CHARACTERS

1 Bearing axle
3 First tube
4 Connection means
5 Second tube
7 End region
9 End region
13 Connector end
15 Transition section
17 Transition section
19 Intermediate region
20 Projection
22 Recess
30 Photovoltaic module
50 System
70 Support leg

What is claimed is:

1. A bearing axle for photovoltaic modules, the bearing axle comprising at least two tubes, which each have a non-circular cross section at least in one end region, wherein
a) the non-circular cross sections of the at least two tubes are designed to correspond to each other such that a non-rotatable connection between at least one first and at least one second of the at least two tubes can be produced by way of inserting the at least one first of the at least two tubes into the at least one second of the at least two tubes, and/or wherein
b) the bearing axle comprises at least one separate connection means which can be arranged intermediately between at least two tubes, and by way of which the particular at least two tubes are connectible non-rotatably to each other by form-lockingly coupling the at least one connection means to their free end regions with non-circular cross sections.

2. The bearing axle as recited in claim 1, in which the particular non-circular cross section of the at least two tubes at least in sections has a polygonal geometry.

3. The bearing axle as recited in claim 2, in which the particular non-circular cross section of the at least two tubes at least in sections has an at least hexagonal and preferably an at least octagonal geometry.

4. The bearing axle as recited in claim 1, in which the at least one first of the at least two tubes has a maximum sectional diameter in the region of its non-circular cross section, which maximum sectional diameter is designed to be smaller than the maximum sectional diameter of a region adjacent to the particular end region.

5. The bearing axle as recited in claim 1, in which an outside diameter of the end region of the at least one first of the at least two tubes and an inside diameter of the end region of the at least one second of the at least two tubes are designed such that the end region of the at least one first of the at least two tubes can be inserted under press fit into the end region of the at least one second of the at least two tubes.

6. The bearing axle as recited in claim 1, in which, in its end region, the at least one first of the at least two tubes terminates in a connector end, the sectional diameter of which successively decreases.

7. The bearing axle as recited in claim 6, in which the connector end in cross section follows a profile which, in relation to a longitudinal axis of the particular at least one first tube, has radial projections and recesses.

8. The bearing axle as recited in claim 7, in which the radial projections and recesses of the particular connector end are formed by an at least approximated wave-formed profile of the at least one first of the at least two tubes.

9. The bearing axle as recited in claim 1, in which one or more of the at least two tubes each have a transition section, with which the particular tube connects to a region adjacent to the end region, wherein the sectional diameter of the transition section successively increases toward the adjacent region.

10. The bearing axle as recited in claim 1, in which the at least one connection means comprises two free end regions by way of which a non-rotatable connection between the two tubes can be produced by means of the two free end regions of the connection means being inserted into or slipped onto free end regions of two tubes.

11. The bearing axle as recited in claim 10, in which the two free end regions of the at least one connection means each have a cross section with a polygonal geometry.

12. The bearing axle as recited in claim 11, in which the two free end regions of the at least one connection means each have a cross section with an at least hexagonal and preferably an at least octagonal geometry.

13. The bearing axle as recited in claim 10, in which the two free end regions of the at least one connection means each have a maximum sectional diameter that is designed to be smaller than in a region of the at least one connection means, which region is arranged intermediately between the free end regions.

14. The bearing axle as recited in claim 10, in which a particular diameter of the free end regions of the at least one connection means and a diameter of a particular end region of the at least two tubes are designed such that the free end regions of the at least one connection means and the at least two tubes can be brought into connection to each other under press fit.

15. The bearing axle as recited in claim 10, in which, in its at least one free end region, the at least one connection means terminates in a connector end, the sectional diameter of which successively decreases with the distance from the opposite free end region of the at least one connection means.

16. The bearing axle as recited in claim 15, in which the particular connector end in cross section follows a profile which has radial projections and recesses in relation to a longitudinal axis of the at least one connection means.

17. The bearing axle as recited in claim 16, in which the radial projections and recesses of the particular connector end are formed by an at least approximated wave-formed profile.

18. The bearing axle as recited in claim 10, in which the at least one connection means has at least one transition section, which adjoins at least one free end region of the at least one connection means, wherein the sectional diameter of the transition section successively increases toward the in each case oppositely located free end region.

19. The bearing axle as recited in claim 10, in which a section having a circular cross section connects to the free end regions of the at least one first of the at least two tubes and/or to the free end regions of the at least one second of the at least two tubes.

20. A system with a plurality of photovoltaic modules, the system comprising at least one bearing axle as recited in claim 1, to which at least one bearing axle at least one photovoltaic module is fastened, wherein the at least one bearing axle is connected to support legs, which are designed for erecting the system on a ground surface.

21. The system as recited in claim 20, in which the at least one bearing axle is connected to an actuator, by means of which the at least one bearing axle as well as the at least one photovoltaic module fastened to the at least one bearing axle can be swiveled.

22. The system as recited in claim 20, in which the at least one photovoltaic module rests on the section with circular cross section and/or is fastened on the section with circular cross section.

23. A method for erecting a system with a plurality of photovoltaic modules, the method comprising the following steps:
assembling a bearing axle for photovoltaic modules, wherein free end regions of at least two tubes, each with non-circular cross section, are put together in a form-locking and non-rotatable manner;
connecting a plurality of support legs to the bearing axle and anchoring the bearing axle in a ground surface by way of the plurality of support legs; and
fastening a plurality of photovoltaic modules to the bearing axle such that the photovoltaic modules of the plurality of photovoltaic modules are held in a non-rotatable manner by the bearing axle.

24. The method as recited in claim 23, in which at least two tubes are put together by way of a common connection means, which is arranged intermediately between the at least two tubes, and to which the at least two tubes each come into connection in a form-locking and non-rotatable manner.

25. The method as recited in claim 23, in which the free end regions of at least two tubes are put together in a directly form-locking and non-rotatable manner.
